(19) United States
(12) Patent Application Publication
(10) Pub. No.: US 2013/0051200 A1
(43) Pub. Date: Feb. 28, 2013

(54) COVER GLASS AND TIMEPIECE

(71) Applicant: Takumi OSHIO, Shiojiri (JP)

(72) Inventor: Takumi OSHIO, Shiojiri (JP)

(73) Assignee: SEIKO EPSON CORPORATION, Tokyo (JP)

(21) Appl. No.: 13/589,424

(22) Filed: Aug. 20, 2012

(30) Foreign Application Priority Data
Aug. 29, 2011 (JP) 2011-186365

(51) Int. Cl. G04B 39/00

(52) U.S. Cl. 368/296

(57) ABSTRACT

To provide a cover glass that is easy to manufacture and a timepiece equipped with the cover glass, a cover glass is a member used by being attached to a body of a timepiece. This cover glass has a plate-like form and includes a cover glass main body and a spacer. The cover glass main body has a transparent quality, and the spacer has a transparent quality, is joined to a back surface of the cover glass main body, and has a ring shape that follows along an edge portion of the cover glass main body. In this cover glass, the cover glass main body and the spacer can be made of the same material or of different materials.

### CROSS-REFERENCE TO RELATED APPLICATIONS

This application claims priority to Japanese Patent Application No. 2011-186365 filed on Aug. 29, 2011. The entire disclosure of Japanese Patent Application No. 2011-186365 is hereby incorporated herein by reference.

### BACKGROUND

1. Technical Field

The present invention relates to a cover glass and a timepiece.

2. Background Technology

In the art, such devices (electronic devices) as, for example, wristwatches, mobile phones, liquid crystal displays, and small game machines (mobile game machines) are provided with a cover glass through which a user views information (e.g., time, date, game content) indicated on an indicating section. In the case of wristwatches, the glass material of the cover glass is sometimes machined to have a polyhedron shape for aesthetic purposes (e.g., see Patent Document 1). In the wristwatch presented in Patent Document 1, a plurality of polyhedron glass member (side glasses) are arranged around a perimeter of the cover glass, again, for aesthetic purposes similarly to the cover glass itself. Thus, the wristwatch presented in Patent Document 1 has a configuration in which multiple glass members are used. As a result, the wristwatch requires more work for assembly and polishing during manufacturing and incurs a higher manufacturing cost.

Japanese Laid-open Patent Application No. 2010-127765 (Patent Document 1) is an example of the related art.

### SUMMARY

### Problems to Be Solved by the Invention

An advantage of the invention is to provide a cover glass that is easy to manufacture and a timepiece equipped with the cover glass.

### Means Used to Solve the Above-Mentioned Problems

How the invention achieves this advantage will now be explained. A cover glass according to the invention is a cover glass used by being attached to a case of a timepiece and includes a cover glass main body having a transparent quality and a ring-shaped spacer that is joined to a back surface of the cover glass main body and configured to follow along an edge portion of the cover glass. As a result, the cover glass is easy to manufacture.

In the cover glass according to the invention, the spacer preferably has a transparent quality. In this way, there will be portions where the cover glass main body is alone and portions where the cover glass main body and the spacer overlap each other and the latter portions will appear thicker and more substantial than the former portions. In the cover glass according to the invention, the spacer preferably has been colored. In this way, the cover glass will have a bordered look and the aesthetic appeal will be increased.

In the cover glass according to the invention, the cover glass main body is preferably convexly curved at least in a middle portion of a front surface thereof. In this way, for example, the entire timepiece will have a superior aesthetic appeal and increased design appeal. In the cover glass according to the invention, the back surface of the cover glass main body preferably has a planar shape. In this way, the work of joining the spacer to the back surface of the cover glass main body can be accomplished more easily. In the cover glass according to the invention, the cover glass main body is preferably concavely curved at least in a middle portion of the back surface thereof. In this way, the cover glass main body becomes comparatively thin and, thus, the cover glass can be made more lightweight.

In the cover glass according to the invention, an ornamental section is preferably provided with at least one of a letter, a numeral, a symbol, and a graphic figure is provided at a joining portion where the cover glass main body and the spacer are joined together. In this way, the ornamental section can be used to have a similar function as, for example, a dial. The cover glass according to the invention is preferably further provided with a ring-shaped frame member that is arranged around an edge portion of the cover glass main body and joined to the spacer. In this way, an outer periphery of the cover glass main body can be protected and, thus, the cover glass main body can be reliably prevented from being damaged due to, for example, an impact.

The cover glass according to the invention preferably includes a positioning means that positions the cover glass main body and the spacer with respect to each other. In this way, the positional relationship can be reliably established when the cover glass main body and the spacer are joined together and the cover glass main body and the spacer can be joined together in the positioned state. In the cover glass according to the invention, the positioning means preferably includes a recess and a protrusion configured to be inserted into the recess, one of the recess and the protrusion being provided on the back surface of the cover glass main body and the other being provided on a front surface of the spacer. In this way, the positional relationship can be reliably established when the cover glass main body and the spacer are joined together and the cover glass main body and the spacer can be joined together in the positioned state.

In the cover glass according to the invention, the recess or the protrusion provided on the cover glass main body has a lens function. In this way, when an ornamental section having at least one of for example, a letter, a numeral, a symbol, and a graphic figure is provided between the cover glass main body and the spacer, the ornamental section can be magnified and emphasized.

A time piece according to the invention is equipped with a cover glass according to the invention and a case onto which the cover glass is attached. In this way, a timepiece having a cover glass that is easy to manufacture can be obtained. An advantage of the invention is to provide a cover glass that is easy to manufacture and a timepiece equipped with the cover glass.

### BRIEF DESCRIPTION OF THE DRAWINGS

Referring now to the attached drawings which form a part of this original disclosure:

FIG. 1 is a perspective view showing a first embodiment in which a timepiece according to the invention is equipped with a cover glass according to the invention and employed in a wristwatch;

FIG. 2 is a cross sectional view taken along a section line A-A in FIG. 1;

FIG. 3 is a cross sectional view showing a second embodiment in which a timepiece according to the invention is equipped with a cover glass according to the invention and employed in a wristwatch;

FIG. 4 is a cross sectional view showing a third embodiment in which a timepiece according to the invention is equipped with a cover glass according to the invention and employed in a wristwatch;

FIG. 5 is a view (plan view) as seen from the direction of an arrow B shown in FIG. 4;

FIG. 6 is a cross sectional view showing a fourth embodiment in which a timepiece according to the invention is equipped with a cover glass according to the invention and employed in a wristwatch; and

FIG. 7 is a cross sectional view showing a fifth embodiment in which a timepiece according to the invention is equipped with a cover glass according to the invention and employed in a wristwatch.

### DETAILED DESCRIPTION OF EXEMPLARY EMBODIMENTS

Preferred embodiments of a cover glass and a timepiece according to the invention will now be explained in detail with reference to the appended drawings.

### First Embodiment

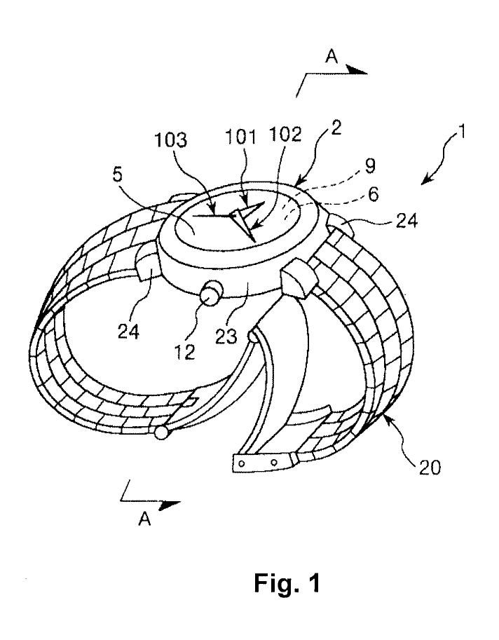

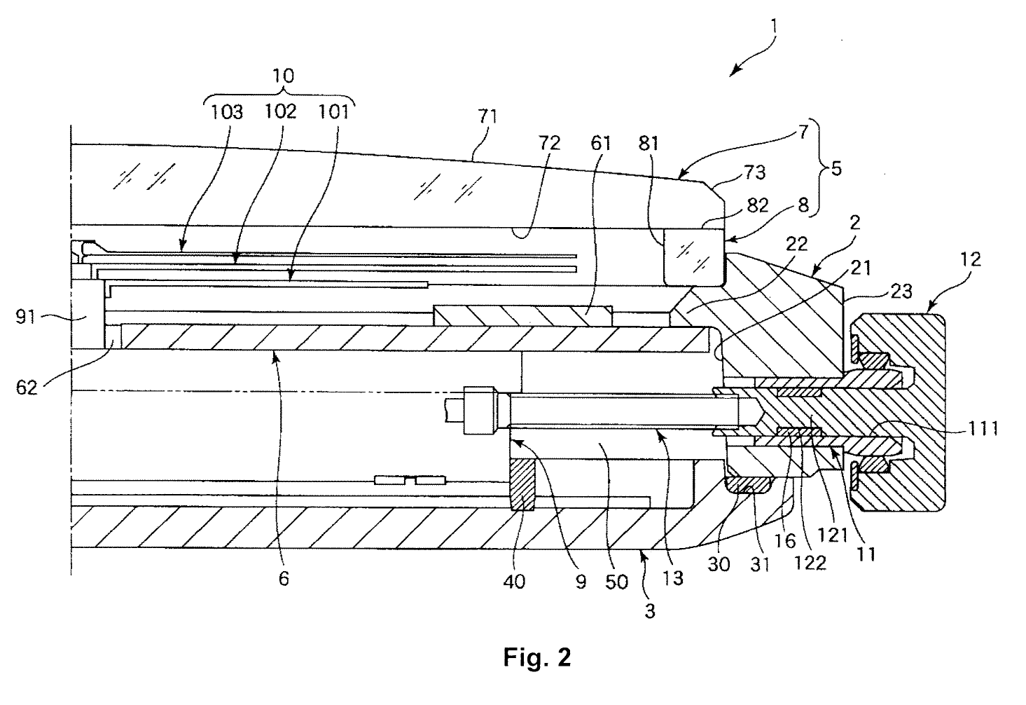

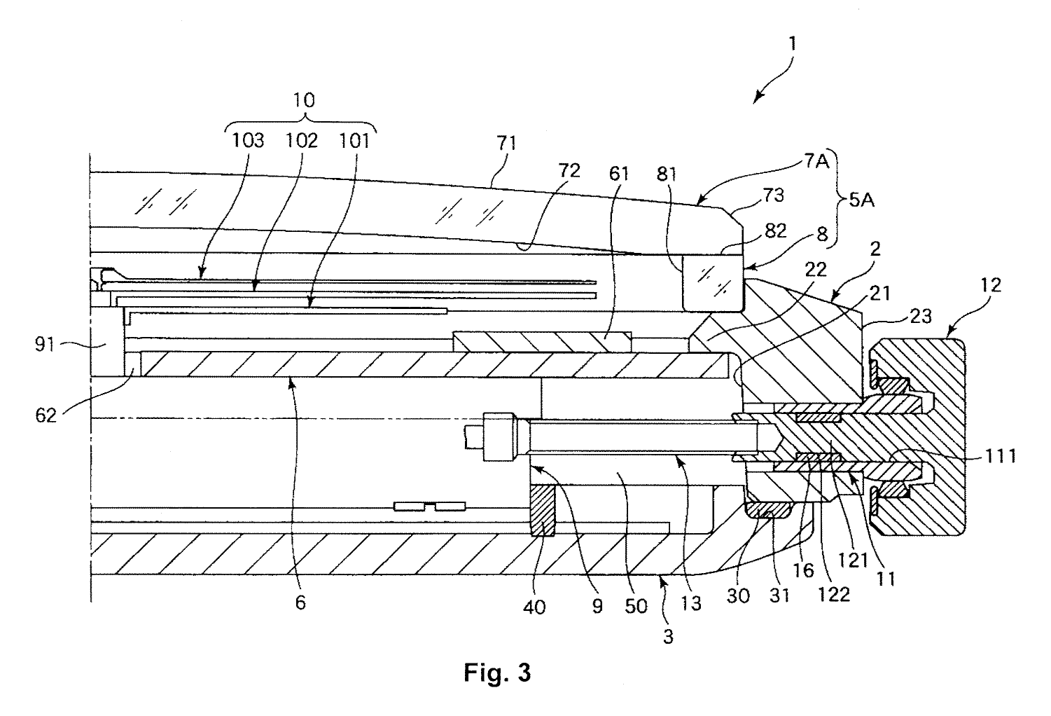

FIG. 1 is a perspective view showing a first embodiment in which a timepiece according to the invention is equipped with a cover glass according to the invention and employed in a wristwatch, and FIG. 2 is a cross sectional view taken along a section line A-A in FIG. 1. In the explanations that follow, such words as “on,” “over,” and “front” refer to the upper side and such words as “under,” “below” and “back” refer to the underside in FIGS. 1 and 2 (as well as in FIGS. 3, 4, 6, and 7).

The wristwatch 1 (hereinafter called simply “timepiece”) shown in FIGS. 1 and 2 has a body (case) 2, a back cover 3, a cover glass (wind shield) 5, and a band 20. A dial 6 and a movement 9 are housed inside an internal space 50 (space surrounded by the body 2, the back cover 3, and the cover glass 5) of the timepiece 1 in order as listed from the side where the cover glass 5 is provided. Indicating needles (hands) 10 (hour hand 101, minute hand 102, and second hand 103) are rotatably supported on the movement 9 and housed inside the internal space 50 of the timepiece 1 along with the movement 9. Constituent features of each of the parts will now be explained.

As shown in FIG. 2, the body 2 is a member having an annular shape. A rib 22 provided on an internal circumferential section 21 of the body 2 extends toward a center of the internal circumferential section 21. The rib 22 is ring shaped and follows along a circumferential direction of the internal circumferential section 21. The cover glass 5 is attached and fixed onto the rib 22 in an airtight and liquid-tight manner. While there are no particular limitations on the fixing method, an example method is bonding (using an adhesive or a solvent).

Lugs 24 that serve as coupling sections for coupling the band 20 are provided on both sides of an external circumferential section 23 of the body 2 with a center axis of the external circumferential section 23 in-between (see FIG. 1). The band 20 is used to attached the timepiece 1 to an arm. A winding stem pipe 11 is press fitted and thereby fixed into a portion of the external circumferential section 23 of the body 2 lying between the lugs 24. A winding stem 121 of a winding crown 12 is rotatably arranged inside the winding stem pipe 11. The winding stem 121 of the winding crown 12 is coupled to the movement 9 through a shaft 13. By rotating the winding crown 12, a torque can be transmitted to the movement 9 through the shaft 13 and the positions of the hour hand 101 and the minute hand 102 can be adjusted.

A groove 122 is formed in the outside circumference of an intermediate portion of the winding stem 121 of the winding crown 12 and a ring-shaped rubber packing (crown packing) 16 is fitted into this groove 122. The rubber packing 16 fits snugly against an internal circumferential surface 111 of the winding stem pipe 11 and is compressed between the internal circumferential surface 111 and the inside surface of the groove 122. This arrangement seals the gap between the crown 12 and the winding stem pipe 11 in a liquid-tight manner and provides a waterproofing effect. When the crown 12 is wound, the rubber packing 16 turns together with the winding stem 121 and slides in a circumferential path along the internal circumferential surface of the winding stem pipe 11 while maintaining a snug fit against the internal surface.

The back cover 3 is attached to a back side of the body 2 with, for example, threaded connection or a press fit. The back cover 3 includes a circular disk shaped member. A recess 31 is formed in a portion (edge portion) of the upper surface of the back cover 3 and configured to following along a circumferential direction of the back cover 3. A packing 30 made of an elastic material is installed into the recess 31. When the back cover 3 is attached to the body 2, the packing 30 is compressed and an airtight and liquid-tight seal can be maintained between the back cover 3 and the body 2.

The back cover 3 is also fixed to the movement 9 through a fixing member 40. The movement 9 has a shaft 91 that rotatably supports the hour hand 101, the minute hand 102, and the second hand 103. The movement 9 includes an internal mechanism configured to drive (rotate) each of the hour hand 101, the minute hand 102, and the second hand 103 through the shaft 91 using electric power supplied from a button cell (not shown in the drawings). Although there are no particular limitations on this mechanism, an example is a mechanism including a quartz oscillator serving as a time measurement reference source, a semiconductor integrated circuit configured to generate drive pulses for driving the timepiece based on the oscillating frequency of the crystal oscillator, a stepping motor configured to receive the drive pulses and drive a wheel train mechanism on a per-second basis, the wheel train mechanism serving to transmit the movement of the stepping motor to the hands.

The dial 6 is placed over the movement 9. As shown in FIG. 2, the dial 6 includes a circular disk-shaped member and is clamped between the movement 9 and the rib 22 of the body 2. As a result, the dial 6 is reliably fixed and reliably prevented from shifting during use of the timepiece. A through hole 62 through which the shaft 91 of the movement 9 is passed is formed in a center portion of the dial 6.

An indicating section (graduated time indicating marks) 61 by which the hour hand 101, the minute hand 102, and the second hand 103 indicate the time of day is provided on the front surface of the movement 9. The time of day can be read based on the positions of the indicating section 61 indicated by the hour hand 101, the minute hand 102, and the second hand 103. While there are no particular limitations on the indicating section 61, examples include the numerals 1 to 12 and symbols or shapes corresponding to these numerals.

Although there are no particular limitations on the materials used to make the body 2, the back cover 3, the dial 6, and the hands 10, examples include such metal materials (including alloys) as stainless steel, titanium, and titanium alloys as well as various resin materials (plastic materials). Among these, metal materials are normally preferred because they have excellent aesthetic appearance and strength. It is acceptable to use the same material for the body 2, the back cover 3, and the hands 10 or to use different materials for the same.

As explained previously, the cover glass 5 is attached to the rib 22 of the body 2. As shown in FIG. 2, the cover glass 5 has a cover glass main body 7 and a spacer 8 that is separate from the cover glass main body 7 but joined to the cover glass main body 7. The cover glass main body 7 has a circular disk-like shape and made of a material having a transparent quality. Here, a “material having a transparent quality” means a material having a transmittance of 50% or higher with respect to visible light. Also, “transparent” means both colorless transparency and color (colored) transparency.

A front surface 71 of the cover glass main body 7 is a convexly curved convex surface spanning from a middle portion to an edge portion, i.e., across the entire front surface 71. In this way, for example, the entire timepiece 1 will have a superior aesthetic appeal and increased design appeal. The “middle portion” the cover glass main body 7 includes not only a center point of the front surface 71 of the cover glass main body 7 but also a region within a prescribed distance from the center point of the front surface 71.

A back surface 72 of the cover glass main body 7 has a planar shape across its entirety. In this way, the work of joining the spacer 8 to the back surface 72 of the cover glass main body 7 can be accomplished more easily. Also, since the planar shape of the back surface 72 and the convexly curved shape of the front surface 71 enable the cover glass main body 7 to function as a lens, the hands 10 and the indicating section 61 of the dial 6, for example, can be emphasized such that they are easier to view. Additionally, a chamfered section 73 is formed on an edge portion of a front side of the cover glass main body 7. As a result, a person's skin can be reliably prevented from being injured if it hits against the front-side edge portion of the cover glass main body 7, for example, and the safety performance of the cover glass 5 can be increased.

The spacer 8 is joined to the back surface 72 of the cover glass main body 7. A front surface 82 of the spacer 8 that joins with the back surface 72 has a planar shape. As a result, the joining work can be accomplished more easily, as explained previously. There are no particular limitations on the method of joining the cover glass main body 7 and the spacer 8 together. Examples include bonding (using an adhesive or a solvent) and welding (thermal fusion, high-frequency welding, ultrasonic welding).

The spacer 8 includes a ring-shaped member that follows along the edge portion of the cover glass main body 7 and has the same external diameter as the cover glass main body 7. As a result, the spacer 8 can be arranged concentrically with the cover glass main body 7 such that the spacer 8 is enveloped by the cover glass main body 7, i.e., such that a situation in which a portion of the space 8 protrudes from the cover glass main body 7 can be reliably prevented. Thus, aesthetic appeal of the cover glass 5 improves. There are no particular limitations on the internal diameter of the spacer 8 so long as an internal circumferential section 81 of the spacer 8 is prevented from interfering with the hands 10.

The spacer 8 preferably has a transparent quality similarly to the cover glass main body 7. In this way, there will be portions where the cover glass main body 7 is alone and portions where the cover glass main body 7 and the spacer 8 overlap each other and the latter portions will appear thicker and more substantial than the former portions. Also, while it is acceptable for the spacer 8 to be colorless transparent or color transparent, it is preferable for the spacer 8 to be color transparent, i.e., to have been colored. In this way, the cover glass 5 will have a bordered look and the aesthetic appeal will be increased.

With the cover glass main body 7 placed on the spacer 8 as explained previously, the cover glass main body 7 protrudes from the rib 22 of the body 2 by an amount equal to the thickness of the spacer 8 and, as a result, the thickness of the timepiece 1 can seem comparatively thick. However, when a user of the timepiece 1 checks the thickness of the timepiece 1, the user will not recognize the total thickness of the transparent cover glass 5 and the non-transparent body 2 as the thickness of the timepiece 1. Instead, the user will ignore the thickness of the transparent cover glass 5 and recognize the thickness of the non-transparent body 2 as the thickness of the timepiece 1. Thus, the timepiece 1 will seem comparatively thin, i.e., lightweight, to the user of the timepiece 1.

Since the thickness of the spacer 8 can serve to ensure that the internal space 50 has as large a volume as possible, the body 2 can be comparatively thin. Particularly, when the timepiece 1 is an electronic timepiece having an antenna that receives an electromagnetic GPS measurement signal from a GPS satellite, the antenna is housed inside the internal space 50 and thus this configuration of the cover glass 5 is advantageous. By merely preparing spacers 8 of different thicknesses, the spacer 8 can be selected as appropriate based on the size of the structure to be housed inside the timepiece 1. For example, if the timepiece 1 is the aforementioned electronic timepiece, an appropriate spacer 8 can be selected from among the spacers 8 having different thicknesses in accordance with the size of the antenna.

With such a timepiece 1, the cover glass 5 includes two members, i.e., the cover glass main body 7 and the spacer 8. The cover glass main body 7 and the spacer 8 each have simple shapes, that is, the cover glass main body 7 has a simple plate-like shape and the spacer 8 has a simple ring-like shape. As a result, the cover glass main body 7 and the spacer 8 can each be formed easily when they are manufactured by a forming process (e.g., molding). Also, the cover glass main body 7 and the spacer 8 are both parts that are polished and the polishing work can be accomplished more easily because they separate parts with simple shapes. Furthermore, the cover glass 5 can be obtained easily and reliably by performing the simple task of assembling and joining the cover glass main body 7 and the spacer 8 together.

There are no particular limitations on the material from which the cover glass main body 7 and the spacer 8 are made; one example is inorganic glass. Examples of inorganic glasses include soda lime glass, borosilicate glass, Hardlex (strengthened organic glass), Clearlex (antireflective treatment), spinel glass, and sapphire glass. With inorganic glass, since the material strength (strength) is high, deformation and cracking, for example, caused by pressure or impact can be reduced, the material is scratch resistant, and a good mirror surface can be achieved. As a result, the cover glass 5 can be imparted with high strength and good visibility. Also, with inorganic glass, bonding with an adhesive can be accomplished easily and, thus, a wide range of adhesive agents and bonding methods can be selected from to obtain a high adhesive strength.

It is acceptable for the cover glass main body 7 and the spacer 8 to be made of the same material or to be made of different materials. If they are made of the same material, then the types of materials used will be fewer and the cost of manufacturing the cover glass 5 can be reduced. Also, since the coefficient of thermal expansion of the cover glass main body 7 and the spacer 8 can be made the same, it is possible to avoid such conditions as warping, sagging, and adhesive separation that might occur when the cover glass 5 was exposed to a temperature change if the cover glass main body 7 and the spacer 8 were made materials having different thermal expansion coefficients.

Meanwhile, if different materials are used, then materials that are well suited to the respective forming processes of the cover glass main body 7 and the spacer 8 can be used. For example, the cover glass main body 7 can be made of a comparatively hard sapphire glass and the spacer can be made of soda lime glass having excellent machining properties (comparatively easy to machine).

### Second Embodiment

FIG. 3 is a cross sectional view showing a second embodiment in which a timepiece according to the invention is equipped with a cover glass according to the invention and employed in a wristwatch. The second embodiment of a cover glass and a timepiece according to the invention will now be explained with reference to this drawing. The explanation will focus chiefly on the differences with respect to the previously explained embodiment and explanations of parts that are the same will be omitted. This embodiment is the same as the first embodiment except that the shape of the cover glass is different.

In the cover glass 5A of the timepiece 1 shown in FIG. 3, the cover glass main body 7A is configured such that the portion of the back surface 72 other than a portion that is joined to the spacer 8, i.e., a middle portion of the back surface of the cover glass main body 7A, is a is a concavely curved concave surface. The curvature of the concave surface of the back surface 72 is the same as the curvature of the convex surface of the front surface 71. The “middle portion” of the cover glass main body 7A includes not only a center point of the cover glass main body 7A but also a region within a prescribed distance from the center point. Thus configured, the cover glass main body 7A is thinner than the cover glass main body 7 of the first embodiment. As a result, the timepiece 1 (cover glass 5A) can be made lighter in weight.

### Third Embodiment

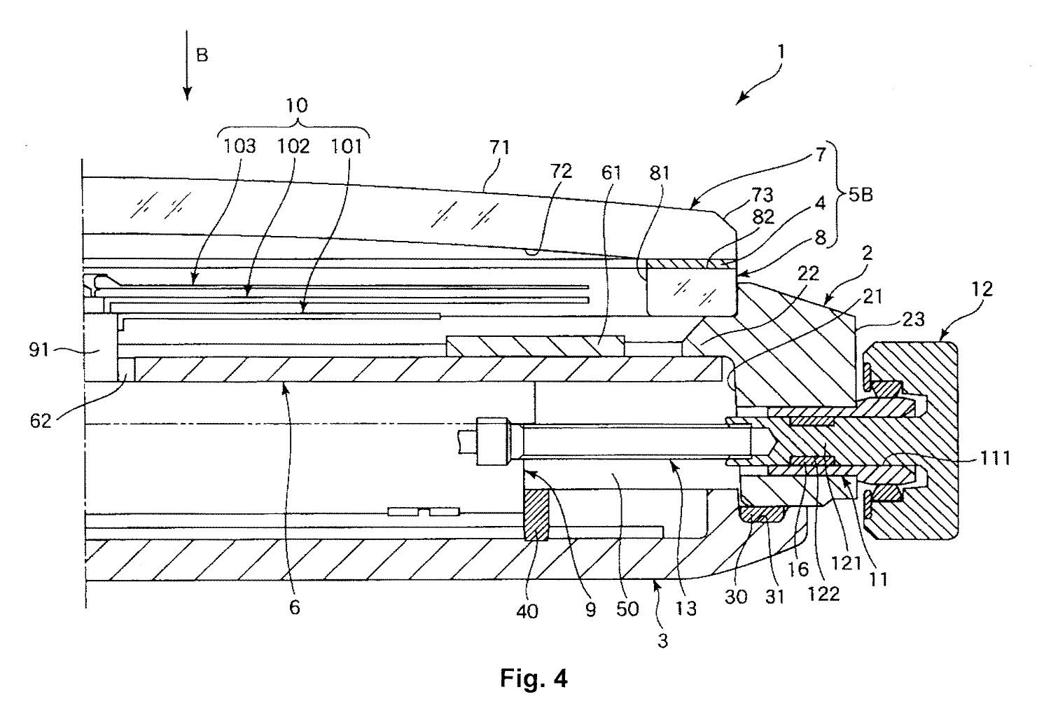

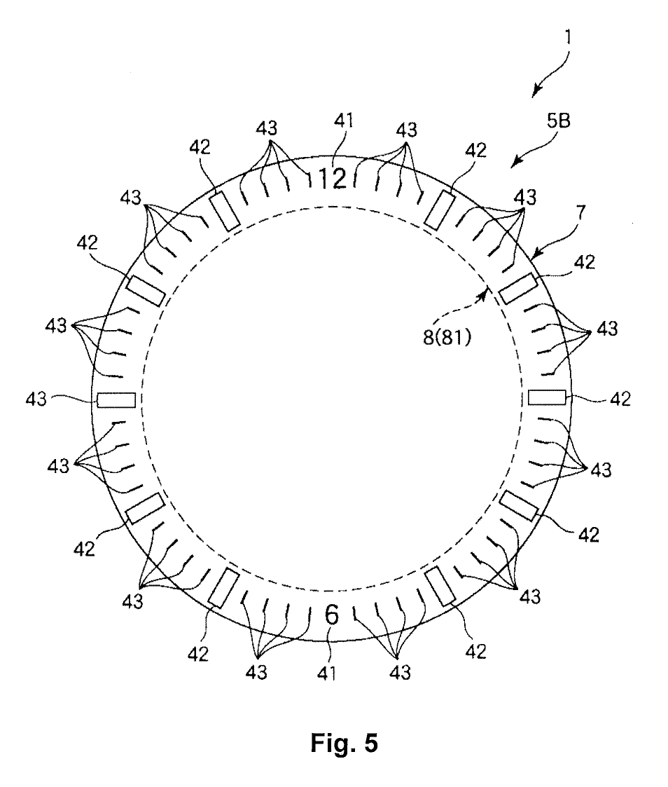

FIG. 4 is a perspective view showing a third embodiment in which a timepiece according to the invention is equipped with a cover glass according to the invention and employed in a wristwatch, and FIG. 5 is a view (plan view) from the direction of an arrow B shown in FIG. 4. The third embodiment of a cover glass and a timepiece according to the invention will now be explained with reference to these drawings. The explanation will focus chiefly on the differences with respect to the previously explained embodiment and explanations of parts that are the same will be omitted. This embodiment is the same as the first embodiment except that the structure of the cover glass is different.

In the cover glass 5B of the timepiece 1 shown in FIGS. 4 and 5, an ornamental section 4 is provided between the cover glass main body 7 and the spacer 8, i.e., in the joining portion where the cover glass main body 7 and the spacer 8 are joined together. In the example shown in FIG. 5, the ornamental section 4 is provided with numerals 41 and FIGS. 42 and 43. The numerals are “6” and “12” and are arranged in positions corresponding to six o'clock and twelve o'clock, respectively. The FIGS. 42 are rectangles arranged in positions corresponding to one o'clock, two o'clock, three o'clock, four o'clock, five o'clock, seven o'clock, eight o'clock, nine o'clock, ten o'clock, and eleven o'clock. The FIGS. 43 are line-shaped and arranged in positions corresponding to minutes.

Thus, in the timepiece 1 of this embodiment, the ornamental section 4 can be used to have a similar function as, for example, a dial. Also, the ornamental section 4 can be something on which printing has been executed or on which a sheet material has been attached. Although in the example shown in the drawings the ornamental section 4 has numerals and graphical figures, the ornamental section 4 is not limited to these and can be provided with at least one of a letter, a numeral, a symbol, and a graphic figure.

### Fourth Embodiment

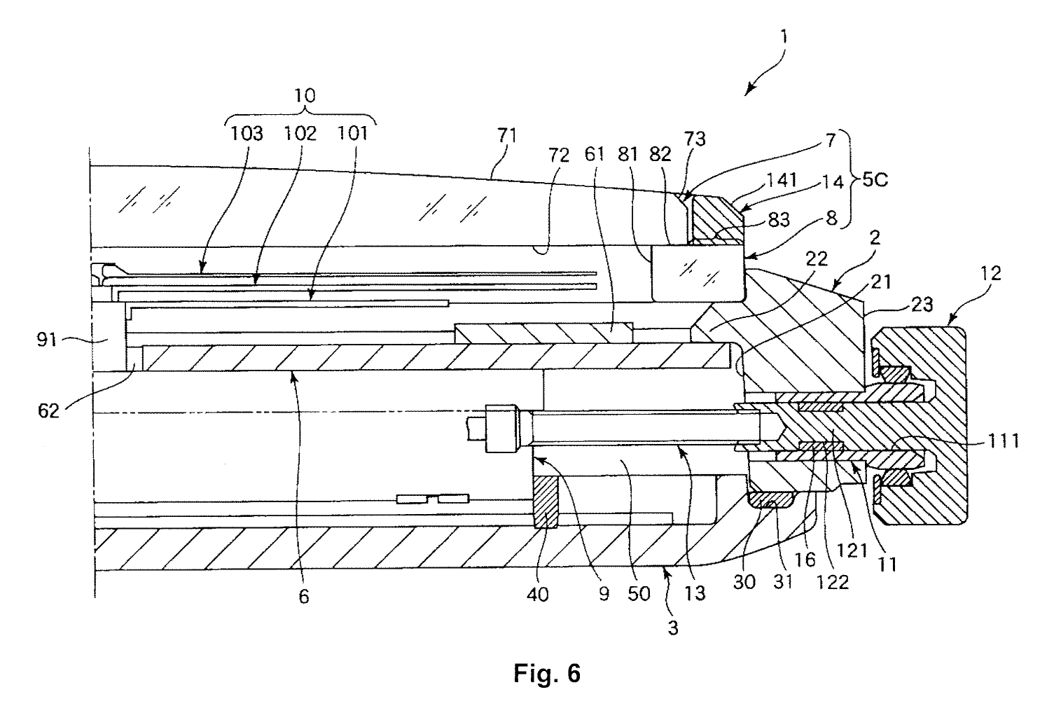

FIG. 6 is a cross sectional view showing a fourth embodiment in which a timepiece according to the invention is equipped with a cover glass according to the invention and employed in a wristwatch. The fourth embodiment of a cover glass and a timepiece according to the invention will now be explained with reference to this drawing. The explanation will focus chiefly on the differences with respect to the previously explained embodiment and explanations of parts that are the same will be omitted. This embodiment is the same as the first embodiment except that the structure of the cover glass is different.

The cover glass 5C of the timepiece 1 shown in FIG. 6 has a ring-shaped frame member 14. The frame member 14 has an internal diameter that is slightly larger than an external diameter of the cover glass main body 7. There are no particular limitations on the material used to make the frame member 14; for example, the same material as the body 2 can be used. In the cover glass 5C, the external diameter of the spacer 8 is larger than the external diameter of the cover glass main body 7 and, in accordance with the increased size, the spacer 8 has a protruding section 83 that protrudes outward beyond the cover glass main body 7. The frame member 14 is arranged on the protruding section 83 of the cover glass main body 7 at the edge of the cover glass main body 7. The frame member 14 is also joined to the protruding section 83.

With this kind of frame member 14, an outer periphery of the cover glass main body 7 can be protected. In this way, the cover glass main body 7 can be reliably prevented from being damaged due to, for example, an impact. Additionally, a chamfered section 141 is formed on the front side of the edge portion of the frame member 14. As a result, a person's skin can be reliably prevented from being injured if it hits against the front-side edge portion of the frame member 14, for example, and the safety performance of the cover glass 5C can be increased.

### Fifth Embodiment

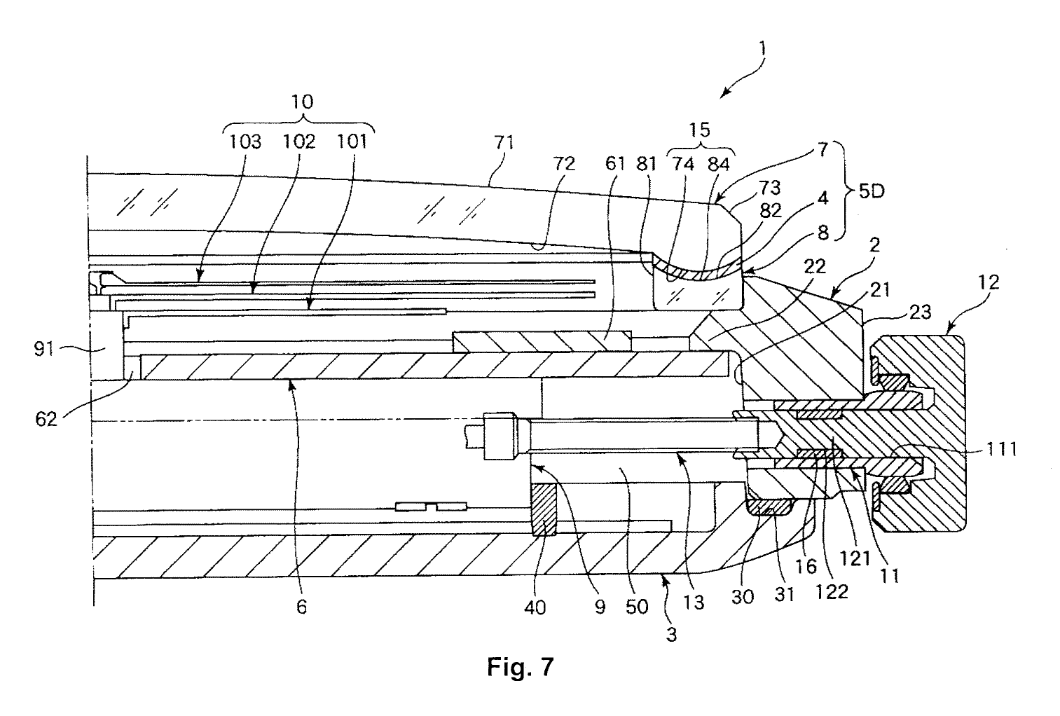

FIG. 7 is a cross sectional view showing a fifth embodiment in which a timepiece according to the invention is equipped with a cover glass according to the invention and employed in a wristwatch. The fifth embodiment of a cover glass and a timepiece according to the invention will now be explained with reference to this drawing. The explanation will focus chiefly on the differences with respect to the previously explained embodiment and explanations of parts that are the same will be omitted. This embodiment is the same as the third embodiment except that the shape of the cover glass is different.

The cover glass 5D of the timepiece 1 shown in FIG. 1 is provided with a positioning means 15 serving to position the cover glass main body 7 and the spacer 8 with respect to each other. The positioning means 15 includes a recess 84 provided in the front surface 82 of the spacer 8 and a protrusion 74 provided on the back surface 72 of the cover glass main body 7. The recess 84 and the protrusion 74 are curved surfaces having the same curvature and the protrusion 74 inserted into the recess 84. This insertion positions the cover glass main body 7 and the spacer 8 with respect to each other. The cover glass main body 7 and the spacer 8 are then joined together in this positioned state.

The protrusion 74 of the cover glass main body 7 has a lens function. As a result, the ornamental section 4 can be magnified and emphasized. Although in this embodiment the positioning means 15 includes a recess 84 provided in the spacer 8 and a protrusion 74 provided on the cover glass main body 7, the invention is not limited to such a configuration and it is acceptable for a protrusion to be provided on the spacer 8 and a recess to be provided in the cover glass main body 7.

Although cover glasses and timepieces according to the invention are explained herein based on the embodiments shown in the drawings, the invention is not limited to these embodiments. Each of the parts making up the cover glass and the timepiece can be replaced with other parts having any desired constituent features so long as the parts can achieve the same functions. It is also acceptable to add any desired component parts. Additionally, it is acceptable to obtain a cover glass and timepiece according to the invention by combining any two or more constituent features (characteristic features) of the previously explained embodiments. The cover glass main body is not limited to a configuration in which substantially the entire front surface is a convexly curved surface; for example, it is acceptable if only a region near a middle portion of the front surface is a convexly curved surface. Although the spacer is made of glass in the previously explained embodiments, the spacer is not limited to a glass material and it is acceptable to make the spacer out of, for example, stainless steel or another metal material.

What is claimed is:

1. A cover glass used by being attached to a case of a timepiece, comprising:
a cover glass main body that is plate-like and has a transparent quality;
a spacer that is joined to a back surface of the cover glass main body and has a ring shape that follows along an edge portion of the cover glass main body.

2. The cover glass according to claim 1, wherein the spacer has a transparent quality.

3. The cover glass according to claim 2, wherein the spacer has been colored.

4. The cover glass according to claim 1, wherein the cover glass main body is convexly curved at least in a middle portion of a front surface thereof.

5. The cover glass according to claim 1, wherein the back surface of the cover glass main body has a planar shape.

6. The cover glass according to claim 1, wherein the cover glass main body is concavely curved at least in a middle portion of the back surface thereof.

7. The cover glass according to claim 1, wherein
an ornamental section having at least one of a letter, a numeral, a symbol, and a graphic figure is provided at a joining portion where the cover glass main body and the spacer are joined together.

8. The cover glass according to claim 1, further comprising a ring-shaped frame member that is arranged around an edge portion of the cover glass main body and joined to the spacer.

9. The cover glass according to claim 1, further comprising a positioning means that positions the cover glass main body and the spacer with respect to each other.

10. The cover glass according to claim 9, wherein
the positioning means preferably includes a recess and a protrusion configured to be inserted into the recess, one of the recess and the protrusion being provided on the back surface of the cover glass main body and the other being provided on a front surface of the spacer.

11. The cover glass according to claim 10, wherein the recess or the protrusion provided on the cover glass main body has a lens function.

12. A time piece equipped with a cover glass according to claim 1 and a case onto which the cover glass is attached.
